(19) United States
(12) Patent Application Publication
(10) Pub. No.: US 2002/0111847 A1
(43) Pub. Date: Aug. 15, 2002

(54) System and method for calculating a marketing appearance frequency measurement

(75) Inventor: James R. Smith II, West Hollywood, CA (US)

Correspondence Address: word of net acquistion corp., 1430 glencoe drive, arcadia, CA, 91006, US

(73) Assignee: Word of Net, Inc.

(21) Appl. No.: 09/733,754

(22) Filed: Dec. 8, 2000

(51) Int. Cl. G06F 17/60

(52) U.S. Cl. 705/10; 707/3

(57) ABSTRACT

A method of determining a marketing appearance frequency measurement is provided. The method includes the steps of measuring how visible to potential customers a company's point(s) of presence are within certain specified media spaces and how well the visibility within those same media spaces causes customers to exhibit certain behaviors. The resulting measurement is calibrated in such a way that the marketing frequency appearance measurement can be used as a predictor of behavior in the form of measurable business attributes such as traffic, sales, stock price, awareness, etc. The method applies for online media spaces, offline media spaces, or both, and the method further includes the step of validating the marketing appearance frequency measurement to known customer traffic, company revenue, or any number of other business attributes.

### FIELD OF THE INVENTION

The present invention relates to a system and method for calculating a marketing appearance frequency measurement that is representative of the visibility of at least one type of point of presence for a company in a particular media space or spaces.

### BACKGROUND OF THE INVENTION

It is important for companies to be able to measure the effectiveness of their marketing activities so that they can determine if the resulting increase in customers will justify the costs of their marketing activities. Measuring marketing effectiveness, therefore, allows a company to identify the activities and strategies that work and to eliminate those that do not. In order to measure the effectiveness of a campaign, a company needs to know who is contacting the company and how they found them, that is, which advertisement or point of presence was successful in bringing the customer and the company together. In addition, a company needs a measure of the effectiveness of a campaign based on some business attribute such as customer traffic, sales, stock price, awareness, etc. Therefore, techniques for measuring marketing effectiveness need to take into account the different ways that people can find a company and be calibrated to the attribute that measures success. This invention combines these two goals into a single measure of the effectiveness of a marketing program in bringing people to a company.

In the past, the best method for measuring the success of a program was to directly measure the increase in customer traffic, sales, stock price, awareness, etc. that resulted from a particular marketing activity. Unfortunately, such measurements are plagued by uncertainty regarding several variables that make such measurements virtually impossible. For example, it is difficult to distinguish between traffic that results from a marketing activity, traffic that would have occurred anyway, and traffic that occurred accidentally through poor marketing programs of competitors. It is also difficult to distinguish first-time visitors from return visitors, and to determine the demographic constitution of the customer traffic.

Further, it is impossible to measure the traffic of a competitor, to accurately predict changes in traffic that will result from marketing efforts, or to secure a validating external measurement of customer traffic predictions.

A mechanism that is sometimes used to identify the traffic and the source of the traffic is to establish a different point of presence for each media space or advertisement campaign within a media space. For example, a company may purchase a new telephone number and display only that phone number on one type of billboard advertisement. By measuring the traffic through that number a company can directly measure the effectiveness of the campaign. But this tends to dilute brand awareness, is not easy to compare over time because of changes to the marketplace, and in any event cannot provide information about competition.

There are also methods for estimating traffic or effectiveness of a marketing campaign indirectly. The most common method is the poll. In a poll, a number of participants are selected and queried about their visits to a company. The poll, however, provides an imperfect estimate of the amount of traffic a company receives and an imperfect estimate of the demographic breakdown of that traffic. In another type of poll, customers are asked questions designed to elicit their awareness of the target company or company brand. But studies show that customer awareness has a correlation to customer traffic of as low as 38%. Moreover, there is continuing debate regarding the validity of poll results in the area of marketing effectiveness, and the costs of such polls makes their regular use impracticable. Finally, there is no currently known method that is effective at identifying the factors that contribute toward generating traffic. Known methods such as polls can do this to a limited extent, but because they typically employ limited sample sizes, they are likely to miss or misrepresent the causes of the measurement.

Accordingly, a need exists for a system and method of calculating a measurement based on readily observable data that may be correlated to a business attribute, including such attributes as traffic, sales, stock price, advertising expenditures, and awareness, with a high degree of accuracy. Such a system and method would be beneficial not only because they could be used to quantitatively estimate the current status of the business attribute, such as traffic, but also because they could be used to determine the effectiveness of marketing campaigns by measuring the change in the measurement or visibility of the company.

### SUMMARY OF THE INVENTION

In accordance with one aspect of the invention, there is provided a method of determining a marketing appearance frequency measurement. The method includes the steps of determining the number of times at least one target point of presence for a company appears within at least one media space, calculating weighted values for each appearance, summing the weighted values to calculate an open score, and calculating a marketing appearance frequency measurement for the at least one target point of presence. According to the method, the weighted values are weighted so that the marketing appearance frequency measurement is proportional to a business attribute to be tracked. As a result, the measurement is representative of the relative visibility of the target point or points of presence found within the media space or spaces searched, where visibility is a measure of the frequency with which consumers see and act upon the observed point or points of presence in terms of the business attribute being tracked. Thus, the degree of correlation between the resulting marketing appearance frequency measurement and the business attribute being tracked can be improved by weighting each appearance of each target point of presence in the media space or spaces searched to approximate the likelihood each appearance will be seen and effect the desired business attribute.

According to a preferred implementation of the method, the frequency measurement is equal to an exponential function of the open score adjusted for the scope of the search.

The method may be applied to online media spaces, offline media spaces, or both. Thus, a point of presence for purposes of the present invention is intended to refer broadly to the various ways that a consumer may be put in touch with a company or become aware of the company or one of its brands; in other words, a point of presence may identify or embody a means of contacting the company or merely be a means of generating consumer recognition or brand awareness. Non limiting examples of points of presence for purposes of the present invention include, but are not limited to, phone numbers, URLs, advertisements, trade names, trademarks, and service marks.

In accordance with a second aspect of the invention, there is provided a computer system that includes a memory configured to store a computer program and data and a processor configured to run the computer program. The computer program is configured to (1) search certain pages on certain World-Wide Web sites to collect a set of observations relating to at least one target point of presence, (2) compute weighted values for each appearance of the target point or points of presence, (3) compute an open score by summing the weighted values, and (4) compute a marketing appearance frequency measurement, wherein the weighted values are weighted so that the marketing appearance frequency measurement is proportional to a business attribute to be tracked. In a preferred implementation of the system, the computed marketing appearance frequency measurement is equal to an exponential function of the open score adjusted for the scope of the search. In addition, the weighted values are preferably weighted to represent the likelihood each appearance will be seen and effect the business attribute being tracked.

Other and further objects, aspects and advantages of the invention will be apparent to those skilled in the art from the description and claims below.

### BRIEF DESCRIPTION OF THE DRAWINGS

In the figures of the accompanying drawings, like reference numbers correspond to like elements, in which:

FIG. 1 is a diagram illustrating a method for calculating a marketing appearance frequency measurement in accordance with one embodiment of the invention.

FIG. 2 is a diagram illustrating a computer network in which the method of FIG. 1 can be applied.

FIG. 3 is a diagram illustrating linear regression performed on data obtained using the method of FIG. 1.

### DETAILED DESCRIPTION OF THE PREFERRED EMBODIMENTS

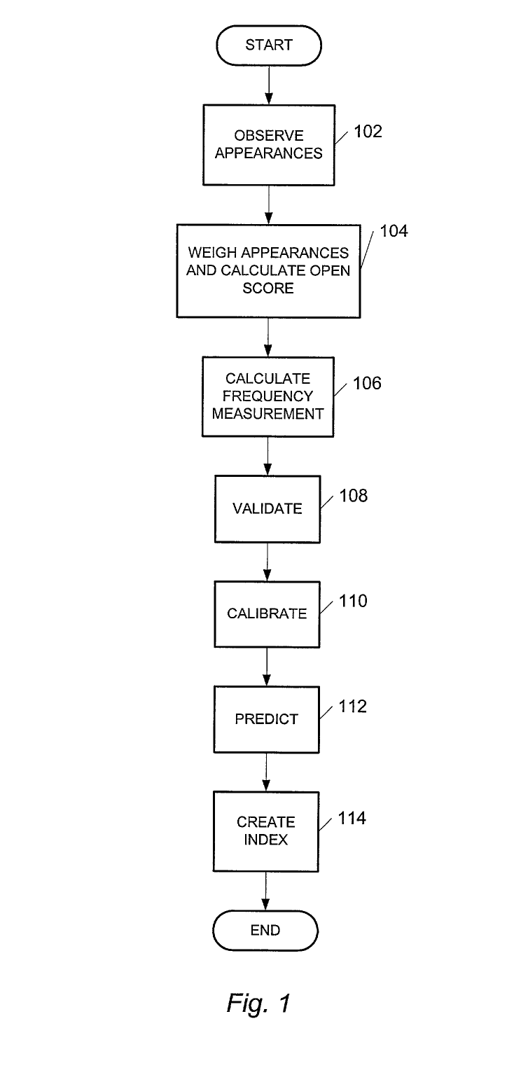

FIG. 1 illustrates a stable methodology for calculating a marketing appearance frequency measurement, according to an embodiment of the present invention. As explained in more detail below, the marketing appearance frequency measurement calculated in accordance with the present invention may be used to predict traffic and thus the effectiveness of marketing campaigns. It may also be used to determine and accurately predict other relevant business attributes, including, but not limited to, a company's sales revenue, return on investment, cost of acquisition, stock valuation, advertising expenditures, awareness, etc.

There are several prerequisites that any methodology should meet in order to be useful over a broad range of media spaces. First, the method must be repeatable, meaning that anyone collecting observations based on the same data and using the same methodology should achieve equivalent results. Repeatability is useful for validation against known results, and for validation performed by third parties. Second, the method should be consistent, meaning that results should be accurate relative to each other over time, regardless of the scale of the observations collected. Thus, if the fundamental data are unchanged, comparable results should be obtained over time so long as a reasonable set of observations is collected. Of course, as with most measurements, the more observations that are collected and used, the more accurate the results. But the measurements should remain constant within some allowable range as the amount of data changes. Third, the method should track a known attribute, meaning that the method should allow the observations to be used to make predictions about a well-known measurement, value or business attribute with some degree of repeatable accuracy and consistency.

Two key observations are at the core of the method illustrated in FIG. 1. The first is the recognition of the direct correlation between marketing effectiveness and the visibility of a company's point or points of presence to the public. In other words, the more information about the company, e.g., advertisements, visible to the public the more effective the marketing activity. Thus, for example, the more times a company has its name appearing on billboards, in telephone books, on television, on the Internet, etc., the more visible the company is likely to be. These different arenas that a company's point(s) of presence can be seen are termed media spaces. The second key observation is the recognition that an evaluation of how visible a company's point or points of presence are within certain media spaces can be correlated to several different measurable business attributes effected by the marketing activity of the company, including such business attributes as customer traffic, sales revenue, return on investment, cost of acquisition, stock valuation, advertising expenditures, etc.

The invention quantifies the visibility of a company's point or points of presence into a number. The quantification process combines information about the quantity and quality of the point(s) of presence as they appear in the media spaces searched, and then adjusts the visibility to take into account the scope of the search. The adjustment is performed so that the quantification will be scalable to different size searches and thus yield comparable results over time. Quality refers to weighing the visibility based on the media space and the placement within that media space in such a way that a desired business attribute is correlated to the underlying visibility. Thus, for example, quantifying the visibility in terms of its quality, typically includes weighing the observations collected in terms of how likely it is that a placement within a particular media space is likely to be seen and thus have the desired effect on the business attribute being tracked. As a result, the marketing appearance frequency measurement of the present invention does not just look at the number of placements or appearances in a particular media space or spaces, but rather it also takes into account the quality of the placements or appearances as well.

The above principles will be further explained in relation to web sites and web site traffic based on the visibility of a company's point or points of presence in online media spaces. It should be kept in mind, however, that the discussion as it relates to web sites and web site traffic is by way of example only, because, as those skilled in the art will realize, the invention applies to both online and offline points of presence, as well as to online and offline media spaces.

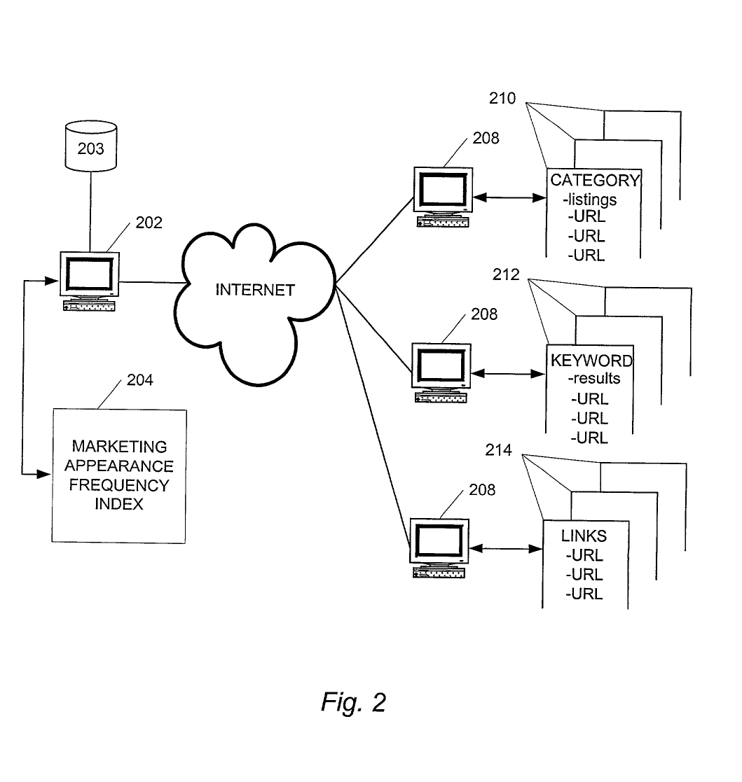

The network 200 in FIG. 2 will now be used to illustrate how the process of FIG. 1 may be implemented in an online environment to predict a web site's traffic. First, in step 102, the number of times that a web site's point or points of presence appear within one or more media spaces is determined. Because the point(s) of presence most relevant to a web site's visibility as it relates to traffic are the URL or lURLs linking to the web site, in the present embodiment this may be accomplished by searching the desired media spaces on the World-Wide Web to find the number of links to, or listings for, the company's web site. For example, a computer program running on a computer 202 will go out onto the Internet and search web sites on servers 208 that are also connected to the Internet. The program is designed to search the sites that comprise online media spaces that have an impact on a web site's visibility. For example, in a preferred implementation, the results of keyword searches performed on Internet search engines are searched to determine whether the web site's URL or URLs appear. Additionally, or in the alternative, category hierarchies on Internet search engines can be searched, as well as incoming links on non-search engine third party sites.

These three online media spaces have been found to be the most significant sources of online traffic. As a result, a marketing appearance frequency measurement calculated based on the visibility of a web site in all three of these media spaces will exhibit a high degree of correlation to a web site's traffic and be more consistent over time. Accordingly, when the marketing appearance frequency measurement is to be correlated to traffic, preferably it is calculated using data collected from all three of these media spaces.

As those skilled in the art will appreciate, other media spaces that are sources of online visibility that can drive traffic to a site may also be incorporated into the marketing frequency measurement calculation. Additional media spaces that are sources of online visibility include, for example, online advertising, including banner ads, online news sources, mentions in discussion groups, mentions in chat rooms, and mentions in news groups. Searching these additional media spaces for appearances of the web-site's URL and including the resulting observations in the marketing appearance frequency measurement will further improve the accuracy of the resulting frequency measurement for predicting traffic. Similarly, if a web site's offline point(s) of presence are also considered, the accuracy of the measurement can be even further improved. From a practical standpoint, however, these additional media spaces, and potential drivers of traffic do not need to be considered. This is because the visibility of a web site's point(s) of presence within them has less of an impact on traffic, and thus the added cost and time of searching them for purposes of estimating traffic has a diminishing value of return. Indeed, when the marketing frequency measurement according to the present invention is calculated based simply on the observations collected from keyword searches, category searches, and inbound link searches, the measurement explains about 70% of the variability in a web site's traffic. However, where the measured visibility is considered in conjunction with industry classification variables, the frequency measurement based on these three media sources explains over 85% of the variability in site traffic.

The computer program running on computer 202 may be configured in a variety of ways to determine the number of times the target IRL or URLs appear in the searched media space or spaces. For example, the program may be simply configured to go out onto the Internet to search web sites 208 comprising the desired media spaces and count the number of times each URL for which the marketing appearance frequency measurement is to be calculated appear. Those skilled in the art will recognize, however, that this is not the most efficient means for determining the number of times the target URL or URLs appear in the searched media spaces. Rather, in most implementations of the invention, the user will want to calculate the marketing appearance frequency measurement for a wide variety of web sites or one or more of their associated URLs. Similarly, it may be desirable to calculate the marketing appearance frequency measurement for web sites or their associated URLs for individual media spaces in addition to calculating it for a plurality of media spaces. Thus, in implementing the present invention, it is preferable to configure the program running on computer 202 to conduct a search of each media space or spaces of interest and collect and store all of the URLs observed in one or more tables retained on data base 203. In this manner, the extensive searches of web sites 208 that are associated with the implementation of the present invention will only need to be carried out once, yet data base 203 will contain all of the observations necessary to calculate the marketing appearance frequency measurement for any URL. As those skilled in the art will appreciate, periodic searches of web sites 208 may be conducted to update the observations stored in database 203. For example, it may be desirable to perform the search and store a new set of observations on database 203 on a monthly, biweekly, weekly, or even daily basis.

The keyword search is preferably implemented by searching a set of keywords on multiple search engines. The set should contain at least 500 keywords to obtain meaningful results. Preferably, however, the set contains at least 1,000 keywords, and more preferably the set should contain at least 10,000 keywords. Although every URL that is returned for each individual keyword searched on each search engine may be stored on database 203, it has been found that points of presence that are not in the first 100 to 200 that are returned have negligible impact on a web site's visibility. Accordingly, preferably only the first 100 to 200 URLs returned for each keyword on each search engine, regardless of the web site to which they refer, are recorded as observations on database 203. In this manner, the amount of data collected and stored on database 203 may be minimized without impacting the accuracy of the marketing frequency measurement. It should be noted, however, that even in an embodiment that only uses the first 100 URLs listed in the results, for a set of 10,000 keywords the program will potentially collect and store 1 million URLs per search engine. Therefore, adequate processing and data storage resources must be available to handle the large amounts of data.

The searched keywords may be generated from a variety of sources. For example, third party services that rate keywords in terms of common usage by Web users may be used to develop a list of the top keywords. Additionally, web sites can be “mined” to find terms that can be used as keywords. A company interested in having the marketing appearance frequency measurement calculated for its site could also supply words that it would like used in the search. The method adjusts for the particular number and scope of the keywords and engines searched in a later step, so the set of keywords does not need to remain constant in order for the results to be comparable over successive iterations of the model.

The program running on computer 202 will supply the keywords to multiple search engines on severs 208. Each search engine will return multiple pages 212 of results. The results will list URLs for sites that the search engine deems valuable for those search words. Typically, the URLs on pages 212 are ordered in terms of an estimation of relevance between the keyword and the site. This order may be used in weighing the quality or value of a placement in a later step. The words used in the keyword search may also be individually weighted to represent the marketing response of each word toward the desired measurement of success when calculating the frequency measurement. Similarly, the search engine on which the keyword searches are performed may be individually weighted to represent the marketing response or popularity of each search engine. Accordingly, the search results are preferably stored in a matrix on database 203 so that computer 202 can determine each URL observed for each keyword searched, the search engine on which it was observed, and its position in the search results. A number may be stored in the matrix to represent a URL's position or ranking in the search results; for example, if a URL is the tenth URL listed in the search results for a particular keyword search then that URL would receive a ranking of 10 for that keyword on the corresponding engine being searched and this ranking could be stored in the matrix. Alternatively, as those skilled in the art will appreciate, the search results may simply be stored on database 203 in a manner that would allow computer 202 to subsequently calculate the URLs position or ranking within the search results.

Category hierarchies, as opposed to keyword driven searches, refer to the listing of certain category headings, such as “automobiles,” on search engine web sites. Typically, sub-headings, such as “trucks” or “sedans,” appear under the category headings. Currently, there are approximately 500,000 categories and sub-categories per category type search engine that can be searched. To perform a category search, the program running on computer 202 is configured to search through multiple pages 210 on one ore more search engines that lists URLs based on a directory or hierarchical ordering and observe each URL that is returned. The position of each URL under a category heading or sub-heading may be used in weighing the quality or value of its placement. The popularity of the category or subcategories and the search engine, as well as the number of URLs per page, may also be used as factors in weighing the value of any particular URL observed during the search. Therefore, the search results for the category search are preferably stored in a matrix on database 203 that includes an entry for each URL returned for each category and subcategory searched, the position of the URL in the search results, and the total number of URLs on each page 210 of search results.

As noted above, incoming links on third party referring pages that are not associated directly with any search engine are also sources of traffic. But perhaps more importantly, they are also a critical input that search engines use in order to determine the importance of the links they list.

Incoming links on third party sites are often listed under a links area or on a links page. The links are usually grouped according to a relationship between the web sites represented, such as the type of site or the type of information contained on the site. Therefore, to perform an incoming links search, the program running on computer 202 searches third party sites looking for incoming links in links pages 214 contained on the third party sites. The position of each URL, or the number of URLs, on a links page 214 may be used in weighing the quality or value of an appearance. Typically, however, the number of links or URLs per page is a better measure for use in weighing the quality or value of an appearance in this context. This is because third party referring pages, unlike keyword and category search page results, do not typically display referring links in a hierarchical manner and thus it would be otherwise difficult to assign a rank to the target URL. The popularity of the site on which the incoming links page 214 is found may also be used in weighing the value of any particular URL observed during the incoming links search. Accordingly, preferably a data matrix for inbound links is stored on database 203 that includes an entry for each URL returned for each links page 214 searched and the total number of URLs on each page 214 of search results.

The exact number of third party pages 214, or independent Web pages, that may be searched for inbound links may be varied over a wide range. However, the more independent pages that are searched, the more accurate the final results will be. Preferably the inbound links are observed on at least 100,000 pages, and more preferably inbound links are observed on approximately 1,000,000 independent pages.

After the desired media spaces are searched, in step 104 weighted values representing the quality of each appearance of the target URL are calculated and the weighted values are summed to calculate an open score. A general equation for calculating an open score for each URL is shown below:

$${S}_{u} = {\sum }_{j = 1}^{n} {λ}_{j} {p}_{j}^{{α}_{j}} ; \qquad ( 1 )$$

where:

λⱼ=a weighting factor for search source j;

αⱼ=the decay factor for search source j;

pⱼ=the position or rank of the target URL for search source j;

n =total number of appearances in the sources searched; and

Sᵤ=open score for the target URL.

While equation (1) has been written in terms of calculating an open score for a target URL, equation (1) may also be used to calculate open scores of other types of points of presence.

In equation (1), n refers to the total number of appearances of the target point of presence, here the target URL, that are found in the media space or spaces searched (e.g., the keyword search engine results, category search engine results and/or third party pages). The variable pⱼ is the position, or rank, of the j^{th} appearance of the target URL within the search results. As noted above, however, in some media spaces the position of a particular point of presence is not numerically identifiable in a traditional sense (e.g., incoming links on third party sites). In such situations, the total number of points of presence appearing in the context is preferably used as the rank of the target point of presence. The variable λ is a weighting factor and is preferably representative of the quality of the context in which the j^{th} appearance of the target point of presence or URL was found. For example, in the keyword search λ may take into account the importance or popularity of the keyword and/or search engine. In the context of a category search, λ may take into account the importance or popularity of the directory and/or specific search category. Whereas, in the context of third party site searches for incoming links, λ may take into account the popularity of the site on which the target inbound link was found.

The variable α is a decay factor that adjusts for the location of the URL within the searched context. Thus, for example, it preferably takes into account how consumers behave within a particular context or media space. The value resulting from raising pⱼ to the power of α essentially represents the probability that the j^{th} appearance of the target URL came up high enough in a particular search result that it will be seen by someone once they arrive at the context in which the URL appears.

In view of the foregoing, the λⱼpⱼ^{α}, term in equation (1) represents the weighted value of the j^{th} appearance of the target URL. Furthermore, the values for p, λ and α are preferably selected, as will be discussed more fully below, so that the resulting weighted value for each appearance represents the likelihood that the appearance will be seen and acted upon so as to effect a business attribute being tracked, e.g., traffic in the present embodiment. As a result, the open score combines information about the quality and frequency of the appearances of the target URL in the media spaces or web sites searched.

It should be noted that the open score is designed to be additive for a particular set of lambda values. Thus, for example, separate open scores may be calculated for the keyword search, category search, and third party site searches. These individual open scores may then be added together to calculate a total combined open score (Sᵤₜₒₜₐₗ). Alternatively, using equation (1) the total combined open score may be calculated directly without calculating the component open scores. Similarly, if a web site has one or more URLs, an S_{uTotal} may be calculated for each individual URL to determine the relative visibility of each URL and thus the traffic contributed to the site by each UTRL. Alternatively, a combined open score for the entire web site (S_{website}) may be calculated by summing the total open score for each URL linked to the web site. Further, a combined keyword, category, and inbound link component open score may also be calculated for a plurality of URLs linking to a web site by summing the respective keyword, category, and inbound link scores for each URL linking to the target web site.

After the desired open score is calculated, a marketing appearance frequency measurement is calculated in step 106. An exponential model is used to transform the open score into the frequency measurement. An equation representing a preferred exponential model for calculating a frequency measurement according to the present invention for a URL is shown below:

$${V}_{U} = γ \times [ 1 - {10}^{- {S}_{U} / {S}_{MAX}} ] ; \qquad ( 2 )$$

where:

γ=a scaling factor;

Sᵤ=the open score for the target URL;

Sₘₐₓ=the maximum of all the Sᵤ in the observed media spaces; and

Vᵤ=marketing appearance frequency measurement for the target URL.

Although equation (2) has been written in terms of calculating a marketing appearance frequency measurement for a target URL, equation (2) may also be used to calculate a marketing appearance frequency measurement for other points of presence as well.

The exponential form in equation (2) was chosen so that the resulting exponential term will always be between zero and one. Because the exponential will result in higher scores being near zero and lower scores being near one, the exponential is subtracted from one in the bracketed term. This subtraction inverts the result so that higher scores are near one and lower scores are near zero. The y term is then set equal to the maximum frequency measurement desired, thus setting the range of the resulting frequency measurement. The γ term is a scaling factor of convenience and is simply selected so that the resulting frequency measurement exhibits a desired degree of granularity. In practice, values of about 1000 have been found to provide a desirable level of granularity. However, the actual value used for 1 may be selected over a wide range. Indeed, as those skilled in the art will appreciate, the marketing appearance frequency measurement does not even have to be scaled by γ. In other words, Vu may simply comprise the portion of the equation within the brackets, which is another way of stating that the y scaling factor may equal 1.

The exponential transformation takes into account the fact that as a point of presence typically becomes more visible it will have a diminishing impact on the desired business attribute to which it is correlated, e.g., traffic in the present embodiment. It should be noted however, that the transform is not limited to using a base of 10. Rather, the marketing appearance frequency measurement may be calculated using other bases as well, including, for example, a base of e. Furthermore, although an exponential transformation will be appropriate for calculating a marketing appearance frequency measurement that is directly proportional to most business attributes, those skilled in the art will appreciate that other transformations may be appropriate when tracking certain business attributes. The appropriate transformation, however, can be determined using known linear regression techniques to determine a model that provides a good, and preferably the best, overall fit to known data points for the business attribute being tracked.

The Sᵤ term in equation (2) is the open score calculated using equation (1) that is to be transformed into the marketing appearance frequency measurement. Sₘₐₓ is a de facto weighting factor that automatically adjusts for the number of pages and engines searched in order to allow conversion between different samples on the Web. The utility of the application of this scalar is that it allows the marketing appearance frequency measurement to be calculated for any media space, or any set of media spaces, simply by calculating Sₘₐₓ for those spaces. In other words, the frequency measurement may be calculated for an individual URL for a particular type of search, e.g., keyword, category, third party sites, etc., or it may be calculated for the total open score of a target URL. In addition, because the open scores are designed to be additive as noted above, a marketing appearance frequency measurement may also be calculated for a plurality of URLs, for example, when calculating the frequency measurement for a web site that has a plurality of URLs that link to it.

Those skilled in the art will appreciate that adjustment factors other than Sₘₐₓ can also be used in equation (2) to adjust the open score for the scope of the search. For example, a measurement of the total set of observations made may be substituted for the scaling factor Sₘₐₓ in equation (2). Substitution of the number of observations made for Sₘₐₓ will not change the value of the exponential term, however, if the open score, Sᵤ, is multiplied by an amount equal to the number of observations divided by Sₘₐₓ. This can be readily seen from equation (3) below.

$${V}_{U} = γ \times [ 1 - {10}^{( - {S}_{U} ( OBS / {S}_{MAX} ) / OBS )} ] ; \qquad ( 3 )$$

where:

OBS=the number of points of presence observed when performing step 102.

Equation (3) may be further rewritten as shown in equation (4) below.

$${V}_{U} = γ \times [ 1 - {10}^{( - {S}_{U} / OBS )} ] \qquad ( 4 )$$

where:

S′ᵤ=Sᵤ(OBS/S_{MAX}) (5)

Similarly, by substituting the right side of equation (1) for the open score, Sᵤ, equation (5) may be rewritten as equation (6).

$${S}_{u}^{′} = {\sum }_{j = 1}^{n} {λ}_{j}^{′} {p}_{j}^{{α}_{j}} \qquad ( 6 )$$

where:

λ′ⱼ=λⱼ(OBS/Sₘₐₓ) (7)

Thus, S′ᵤ is simply a modified open score where the λ weighting factors have been adjusted by the (OBS/Sₘₐₓ) term. But because the λ weighting factors are preferably empirically determined and then validated through multidimensional linear regression, the modified λ′ weighting factors may be similarly determined without ever actually quantifying the (OBS/Sₘₐₓ) term. This is because the λ′ values determined in this manner will be automatically adjusted for the (OBS/Sₘₐₓ) term if OBS is used as the denominator in the exponent as shown in equations (3) and (4). In actual practice, however, the X weighting factors may only be adjusted by a value that roughly approximates the (OBS/Sₘₐₓ) term during linear regression. As a result, the exponent −S′ᵤ/OBS may equal values of less than −1 even though equation (2) suggests that the value of the exponent will always be between 0 and −1. In turn, during the practical application of the present embodiment of the invention, the exponential term may range between 0 and 1, whereas equation (2) suggests that the exponential term, from a theoretical standpoint, should range between 0.1 and 1.0. The bracketed portion of the equation, therefore, may range between 0 and 1 in practice, so that higher scores are near 1 and lower scores are near 0.

The practical utility of using the number of observations, OBS, as the adjustment factor for the scope of the search is that the number of observations made during step 102 is a known variable at the start of the calculation. On the other hand, Sₘₐₓ must be determined for each desired media space or spaces being observed by calculating SU for every observed URL in the searched media spaces and then determining Sₘₐₓ from the various open scores calculated. Obviously this would require a significant number of calculations considering the number of different URLs, or other points of presence, that will be observed in a particular media space or spaces. Further, determining an accurate value for Sₘₐₓ in the first instance is made difficult because the values of λ and cc are required to calculate each Sᵤ, yet the most accurate values for these variables are determined through multidimensional linear regression of the marketing appearance frequency measurement to the desired business attribute, such as traffic in the present embodiment. As seen from equation (2), however, Sₘₐₓ is required to calculate the marketing appearance frequency measurement for purposes of performing the linear regression. Thus, using OBS as the adjustment factor also further simplifies the linear regression for determining appropriate estimated values of λ and a because fewer unknown variables must be determined.

From the foregoing discussion, it will be apparent to those skilled in the art that the open score, Sᵤ, may also be entirely adjusted for the scope of the search simply by using appropriate values for the λ weighting factors. For example, if λ′ is set equal to λ/Sₘₐₓ then the exponential transform of equation (2) becomes simply the scaling factor of convenience, γ, times an exponential transform of the modified open score S′ᵤ as seen in equation (8) below.

$${V}_{U} = γ \times [ 1 - {10}^{- {S}_{U}^{′}} ] ; \qquad ( 8 )$$

Thus, the present invention contemplates adjusting the open score for the scope of the search following the calculation of the open score as illustrated in equation (2), simultaneously with the calculation of the open score as illustrated in equation (8), or partially simultaneously with the calculation of the open score and partially following the calculation of the open score as illustrated in equations (4)-(7).

When calculating the open score in practice, the program running on computer 202 is preferably configured to provide a single weighted value that is representative of each appearance of a target point of presence within each media space by applying equation (1) programmatically. A software loop searches the database 203 for the point(s) of presence of interest, and accumulates a value that is increased each time that a target URL is observed, by a value λ′ that is also stored in the database 203 for the keyword, category or inbound page on which the URL was observed, times a quantity derived from the observed rank of the URL on the page raised to the power of a that is stored in the database 203 for that particular context. Then the result is divided by the total number of points of presence observed in order to derive a scaled, comparable number for further transformation in accordance with equation (4).

The marketing appearance frequency measurement calculated in step 106 is designed to be proportional to a business attribute being tracked. A general equation for mapping the marketing appearance frequency measurement to the business attribute being tracked is shown in equation (9) below.

B=βV (9)

where:

B=the estimated business attribute;

V=the calculated marketing appearance frequency measurement; and

β=a scaling factor for mapping V to B.

Equation (9) may be rewritten as equation (10) when an online marketing appearance frequency measurement is being mapped to traffic.

T_{U}=β_{T}V_{U} (10)

where:

T_{U}=estimated traffic for the target URL;

V_{U}=the marketing appearance frequency measurement for the target URL; and

β_{T}=scaling factor for mapping Vu to online traffic.

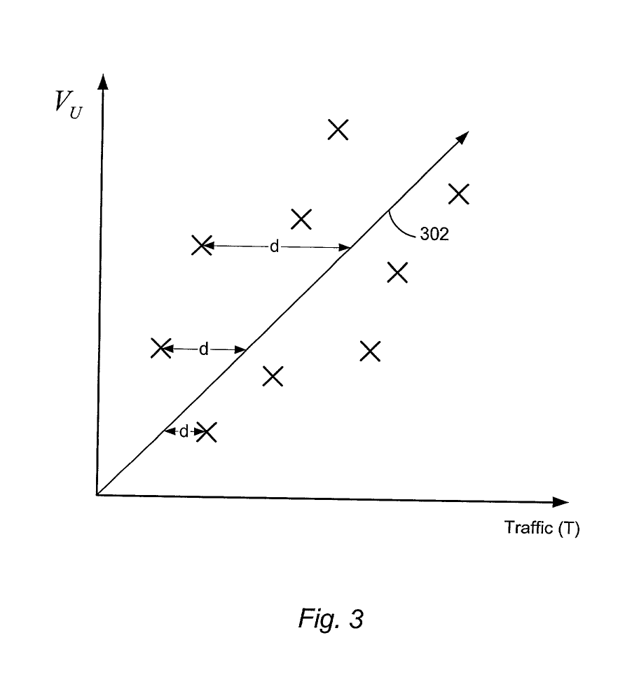

As seen from FIG. 3, the scaling factor β is equal to the inverse of the slope of the line 302. The value of β may, therefore, be estimated by calculating the marketing appearance frequency measurement for a select number of companies or sites having a known value for the business attribute being tracked, such as traffic, and then plotting the calculated marketing appearance frequency measurement against the observed data. The scaling factor β may then be determined from the plotted data in a variety of ways known in the art, including, for example, simple estimation by drawing a line 302 that fits the data. Preferably, however, β is determined through linear regression in order to obtain a line 302 with the best possible fit to the observed data.

In view of the relationship expressed in equation (9), the marketing appearance frequency measurement may be readily validated against known data for the business attribute being tracked. Accordingly, in step 108, the marketing appearance frequency measurement is preferably validated using points of presence with known data points.

For example, in step 108, published web site traffic data for known sites may be used to validate the frequency measurement against traffic through linear regression. The process of linear regression involves plotting the frequency measurement of known sites against observed traffic at the sites as shown in FIG. 3. A line 302 is then fitted to the data in a manner so as to reduce the average distance (d) between the plotted points and line 302, which graphically represents the function expressed in equation (9) above and the predicted values of traffic. The average distance (d) is then analyzed to determine how well the frequency measurement predicts traffic. The smaller the average distance (d) is the more accurate the prediction.

The distances (d) should on average be less than 40% of the observed values for the business attribute being tracked to ensure an acceptable level of accuracy. Preferably, the distances (d) are less than 30% of the observed values on average for the business attribute being tracked, and more preferably they are less than 15% on average.

If the resulting marketing appearance frequency measurement does not predict the business attribute being tracked with the desired level of accuracy, then in step 110 the data from the known sites may be used to tune or calibrate the calculation of the marketing appearance frequency measurement. This may be done by tuning the values of the various λ's and α's to improve the prediction. Linear regression may then be used to verify that the accuracy of the tuned frequency measurement is within acceptable tolerances. It should be noted, however, that a benefit of the present invention is that the accuracy of the predictive value of the frequency measurement is not highly sensitive to the individual λ and a values used in its calculation. Very simple estimates for the values of λ and α can be used and typically the resulting frequency measurement will be sufficiently accurate to track the contemplated business attribute. As a result, the values of λ and α may be estimated empirically and these estimates will typically yield a frequency measurement that tracks the magnitude of the desired business attribute with sufficient accuracy to satisfy most marketing management activities contemplated by the present invention.

A manner in which the values of λ and α may be initially selected and then tuned is now described more fully below.

The λ and α terms can be expected to have certain values in certain contexts. As a result, the values for λ and α may be initially chosen based on empirical information to approximate potential models that describe consumer behavior in the contexts in question.

For example, in an open score calculation based on keyword searches, λ may be estimated based on the keyword's frequency of use on a particular search engine and/or the popularity of the search engine. Thus, for convenience, the λ weighting factor for each appearance may be viewed as comprising a λ_{keyword} component, representative of the relative popularity of the searched keyword, and a λ_{engine} component, representative of the relative popularity of the search engine on which the keyword search was performed. The product of the λ_{keyword} and λ_{engine} weighting factors would then yield the overall λ that would be used for a particular appearance resulting from a keyword search. As those skilled in the art will appreciate, in other contexts, the λ weighting factor may similarly be viewed as comprising one or more component parts.

When initially selecting a value for the λ_{engine} weighting factors, the relative popularity of the engines is preferably considered. For example, if one search engine is twice as popular as another search engine used in the keyword search, it may be desirable to assign a λ_{engine} value to the first engine that is twice as large as the value assigned to the second search engine. Similarly, if a particular keyword is used twice as frequently as another keyword, it may be desirable to initially assign a λ_{keyword} value that is twice that of the second keyword.

While varying λ_{engine} and λ_{keyword} based on the relative popularity of the keyword and engine that resulted in the appearance of the target URL will improve the overall accuracy of the predictive value of the marketing appearance frequency measurement of the present invention, during application of the invention it has been found that suitable results may be obtained by weighting all keywords equally and weighting all engines equally. This is probably due in part to the fact that during application of the invention, the most popular engines and keywords have primarily been used for performing the keyword searches.

For category searches λ may be initially estimated based on the category's popularity or frequency of use and/or the popularity of the search engine on which the category search was performed. Thus, as in the keyword search context, the k weighting factor for each appearance in the category search context may be viewed as comprising a λ_{category} component, representative of the relative popularity of the searched category, and a λ_{engine} component, representative of the relative popularity of the search engine on which the category search was performed. As a rough approximation of the relative popularity of each category, two discrete levels may be used to weight categories, one for high popularity and one for low popularity. In this way, a discrete value may be assigned for each level. For example, high level categories may be assigned a λ_{category} value of 1 and low level categories may be assigned a λ_{category} value of 0.5.

Again, while assigning λ_{category} and λ_{engine} values based on the relative popularity of the category in which the appearance was found and the search engine on which the search was performed should lead to improved accuracy of the model, it has been found that suitable results may also be obtained in practice by weighting category search engines equally and categories equally.

For inbound links, λ is preferably estimated based on the third party web site's relevance and popularity within the industry. Thus, λ may be chosen so that it is proportional to the visibility of the source page. However, it has also been found through application of the invention, that suitable results may also be obtained if each third party page is weighted equally.

As previously noted, α is a decay factor that adjusts for the location of the URL within the searched context. α is typically different for different contexts in which the particular point of presence was found. If α is less than 0 then the contribution of an individual appearance to the total score decreases as its placement on the page decreases. For example, a may equal −1 for search sources where people have to scroll through several pages of information, such as in keyword searches. On the other hand, if α equals 0 then the contribution of an appearance is independent of its placement on a page or other context within which it is found. For example, contexts where people see all of the information at once may have α values equal to 0. This is the typical situation of third party inbound link pages.

After the initial values of λ and α are selected, multidimensional linear regression may be used to compare the contribution of each term in the model to the final result. This method uses the hypothetical or estimated values of λ and a with the observed data in order to obtain predicted values for the business attribute for a sample of known points of presence. The weight of each value in the model is then changed programmatically in order to minimize the total of all of the differences between each predicted value and observed value. This is essentially an iterative process where λ values are tried for a variety of a values to arrive at a suitable combination. However, while the λ values are being varied typically the a values are locked in place and vice versa so that only one variable is altered for each new series of calculations. Through this process, models that contribute to improving the quality of the final result can be quickly identified and distinguished from those that do not.

Thus, for example, if the marketing appearance frequency measurement calculated in accordance with equation (4) above is meant to correlate to web site traffic, the result from equation (4) would be scaled and transformed to approximate traffic. The λ′ values would then be changed slightly and a new prediction of traffic calculated. If the new prediction of traffic is better than the previous one, the new λ′ value would be retained. In a similar manner, the values of α would be changed. This process is preferably used over the collected set of data so that the model becomes altogether a better predictor of traffic.

In one implementation of the invention, where the appearance of web site URLs in search engines, on-line directories and third-party pages is used to calculate a marketing appearance frequency measurement that tracks the traffic of a web site URL, an initial model is used with λ=1 for all keywords and search engines and α=−1 for all keyword contexts; λ=1 for all categories and α=0 for all category contexts; and λ=1 for all third-party pages and α=0 for all third-party contexts. Based on the initial values of λ and α, traffic is predicted for a select number of sites having known traffic. The values of λ and a are then changed iteratively for each component open score (e.g., keyword open score, category open score, and third party search open score) and traffic is again predicted for each new combination of variables for the known sites. The accuracy of the prediction for each combination of λ and α values is then compared in relation to the sum of the absolute value of the differences between the predicted values and the actual recorded values. In this way λ and α values that yield a marketing appearance frequency measurement that is an accurate predictor of traffic may be determined.

As those skilled in the art will appreciate, the values of λ and α may be further refined by iteratively changing the values of λ and α for each individual appearance to take into account, for example, the relative weightings of individual keywords or categories that were searched as well as the individual weightings of each keyword search engine, category search engine, and third party site. By further refining the values of X and a in this manner, the marketing appearance frequency measurement may become a better predictor of site traffic.

To simplify the process of determining λ and α, it is advantageous to calculate separate marketing appearance frequency measurements for the individual component open scores (e.g. keyword search open score, category search open score, and third party search open score) and then separately map these component frequency measurements to traffic. The accuracy of the traffic predictions for the component frequency measurements may then be separately validated and calibrated through the linear regression techniques discussed above. Determining λ and α using component marketing appearance frequency measurements in this manner simplifies the linear regression process because it minimizes the number of variables that may effect the accuracy of the predictive value of the resulting frequency measurement. If the values of λ and α are determined by mapping the component frequency measurements to traffic in this manner, however, then the validation and calibration process is preferably repeated for the combined or multi-component frequency measurement. By repeating the validation and calibration process on the combined frequency measurements, appropriate λ weighting factors for the combined frequency measurement may be determined. This is necessary because each of the searched media spaces will not contribute equally to the traffic experienced by a site in the overall model. However, when determining the λ values for the overall model it is useful to start with the λ values determined from mapping the component frequency measurements to traffic and then tuning the values from there.

Rather than calculating all new λ values, it is also possible to simply calculate adjustment factors that may be applied to each of the individual component open scores when calculating a multi-component marketing appearance frequency measurement based on the combined keyword, category, and third party search open scores. This approach is further illustrated in Example 4 below.

In some circumstances, it is also helpful to categorize the data before validating and calibrating the marketing appearance frequency measurement to the business attribute being tracked. This is because in many practical cases the relationship between visibility and the predictor of the business attribute that is being tracked is computationally distinct for different categories of data. In other words, β in equation (9), and the slope of line 302, may be distinct for different categories of data. For example, in an embodiment where the number of visitors to a particular web site is being predicted, for one industry category the traffic might be twice the calculated visibility (β=2), while for a different industry category, the traffic might be three times the calculated visibility (β=3), even though λ and α are the same for both calculations. This recognizes that λ and α measure the behavior of the consumers in a given marketing space, without the complications of how interested they are in the particular product or material that is being offered.

Although it is possible to categorize industries in a wide variety of ways for purposes of mapping the marketing appearance frequency measurement to traffic, segregation into the following general industry categories has been found beneficial: (1) arts/entertainment, (2) automotive, (3) shopping, (4) finance/investment/investment news/trading, (5) computers/electronics/technology, (6) travel/airlines/agents, (7) news/weather/media, (8) sports, (9) internet/search/internet service providers, and (10) health.

Thus, by using multidimensional linear regression as described above, and preferably categorizing the data into computationally distinct categories, the values of λ and α may be tuned using a large amount of data, and the results tailored to a particular company or industry.

It should be kept in mind that the marketing appearance frequency measurement of the present invention may be used to predict other variables related to customer traffic, such as revenue, advertisement expenditures, and stock prices. Return on other investments besides add expenditures, such as cost of acquisitions, can also be predicted by utilizing the calculated frequency measurement and adjusting the factors to suit the model. Further, for each of these business attributes, as well as others, the frequency measurement can be validated and calibrated through linear regression using the techniques described above as long as known data can be obtained.

Once the frequency measurement is calibrated, it can be used in step 112 to predict desired business attributes, such as traffic or revenue, for points of presence having an unknown value for the business attribute being tracked.

Further, in step 114, a marketing appearance frequency index can be created based on the frequency measurements for multiple companies. For example, when a frequency measurement is calculated for one company, a measurement can also be calculated for every company that appears in the same media spaces, or a select number of predetermined competitors. These measurements can then be aggregated into an index. The advantage is that relations between companies such as relative effectiveness of competing ad campaigns can quickly be determined. Also, the index allows identification of a company's competitors and can help to identify successful techniques for increasing visibility. For example, the source data that comprises the marketing appearance frequency measurement can be used to identify the source of traffic to a company or its competitors and hence the underlying drivers for the measured effect. Indeed one of the benefits of the present invention over currently known methods is that it allows the reporting of a substantial amount of causal data. Those skilled in the art can readily analyze this data to determine appropriate techniques known in the art for boosting the visibility of a particular point of presence. Such techniques include, for example, integrating the media spaces where a competitor's points of presence appear into a company's online marketing strategy for purposes of increasing qualified traffic. Thus, in a preferred implementation of the invention the source data used in calculating the marketing appearance frequency measurement is included in a report with the calculated marketing appearance frequency measurement or measurements. Moreover, because the contribution each appearance makes toward the marketing appearance frequency measurement is calculated in accordance with equation (1), the weighted value of each appearance may be beneficially included in the report next to the corresponding source data related to the appearance. Similarly, the open score for any set of appearances, any individual media space, or collection of media spaces may be reported to enhance the usefulness of the data. Other useful formats for reporting the source data and the constituent elements of the marketing appearance frequency measurement will also be apparent to those skilled in the art.

### EXAMPLE 1

Example 1 illustrates how a keyword marketing appearance frequency measurement may be calculated in accordance with the present invention for a web site's points of presence. In this example, moneycentral.com and its related URLs are used as the target points of presence.

Initially, a plurality of keyword searches was performed on six different keyword search engines. The first 200 URLs returned for each keyword that was searched on each engine were observed. Table 1 lists the first appearance of the target points of presence for each keyword search that resulted in an appearance, the corresponding search engine on which the appearance occurred, and the rank of the appearance in the search results.

TABLE 1

| Engine | Searched Keyword | Rank | Target URL |
|---|---|---|---|
| Yahoo! | personal finance | 96 | www.moneycentral.com |
| Categories | | | |
| Yahoo! | moneycentral.com | 1 | www.moneycentral.com |
| Categories | | | |
| AltaVista | moneycentral.com | 2 | moneycentral.com/discuss/chatsched.asp |
| AltaVista | moneycentral.com | 5 | www.moneycentral.com/insure/home.asp |
| AltaVista | portfolio tracking | 189 | moneycentral.com/home.asp |
| AltaVista | money central | 151 | moneycentral.com/home.asp |
| AltaVista | portfolio tracking | 187 | www.moneycentral.com/home.asp |
| AltaVista | money central | 145 | www.moneycentral.com/home.asp |
| AltaVista | stock ticker | 81 | moneycentral.com/articles/common/summary.asp |
| AltaVista | ticker symbols | 135 | www.moneycentral.com/articles/common/featsec.asp |
| Yahoo! Web | moneycentral.com | 4 | www.moneycentral.com/tax/home.asp |
| Pages | | | |
| Yahoo! Web | moneycentral.com | 5 | moneycentral.com/home.asp |
| Pages | | | |
| AOL | portfolio tracking | 15 | www.moneycentral.com |
| AOL | stock portfolio | 140 | www.moneycentral.com |
| AOL | stock research | 36 | www.moneycentral.com |
| AOL | moneycentral.com | 1 | www.moneycentral.com |
| DMOZ | online stock quotes | 48 | www.moneycentral.com/ |
| DMOZ | portfolio tracking | 29 | www.moneycentral.com/ |
| DMOZ | moneycentral.com | 1 | www.moneycentral.com/ |
| DMOZ | stock portfolio | 81 | www.moneycentral.com |
| DMOZ | stock research | 127 | www.moneycentral.com |

The various parameters needed to calculate the keyword marketing appearance frequency measurement for the moneycentral.com points of presence are now discussed.

First, a total of 764,454 points of presence, or URLs, were observed during the keyword searches performed in the initial step above. Thus, OBS_{keywords}=764,454. Second, the scaling factor of convenience, γ, was set at 999 (γ=999) so that the maximum marketing appearance frequency measurement will be 999. Third, it was determined that the industry unique visitor scaling factor, β_{industry}, equaled 3,055 visitors/month. This was determined through linear regression of the keyword marketing appearance frequency measurement to traffic for sites having known traffic within the same industry as moneycentral.com. Tables 2 and 3 below provide the λ_{engine}, λ_{keyword}, and α values that were also determined in the validation and calibration process through linear regression.

TABLE 2
Engine Weightings

| | Weighting Factor | Decay Factor |
|---|---|---|
| Engine | λ_{engine} | α_{keyword} |
| Yahoo! Categories | 1765 | −1 |
| Google | 1765 | −1 |
| AltaVista | 1765 | −1 |
| Yahoo! Web Pages | 1765 | −1 |
| AOL | 1765 | −1 |
| DMOZ | 1765 | −1 |

TABLE 3
Keyword Weightings

| | Weighting Factor |
|---|---|
| Keyword Phrase | λ_{keyword} |
| personal finance | 1 |
| moneycentral.com | 1 |
| portfolio tracking | 1 |
| money central | 1 |
| stock ticker | 1 |
| ticker symbols | 1 |
| portfolio tracking | 1 |
| stock portfolio | 1 |
| stock research | 1 |
| online stock quotes | 1 |

As seen from Table 1, λ_{engine} is the same for each of the engines. Similarly, from Table 2, it can be seen that λ_{keyword} is the same for each of the keywords. Thus, each keyword search engine and keyword are weighted the same. However, the overall value of each appearance in the keyword search context will vary in the open score calculation based on the rank of the appearance of the target point of presence.

The keyword open score for moneycentral.com may be calculated using equation (1.1) below.

$${S}_{U}^{′} = {\sum }_{sightings} {λ}_{engine}^{′} {λ}_{keyword}^{′} {p}^{{α}_{keyword}} \qquad ( 1.1 )$$

where:

p represents the rank of the UTRL position on the search result page;

λ_{engine}, λ_{keyword} are weighting factors that were initially estimated empirically based on popularity and validated through linear regression; and

α_{keyword} is the decay factor that was modeled on consumer behavior in the keyword search results context and validated through linear regression.

Applying equation (1.1) to the data in Tables 1 through 3 above yields the following open score calculation:

S′_{U}=(1765×1/96)+(1765×1/1)+(1765×1/2)+(1765×1/5)+(1765×1/189)+(1765×1/151)+(1765×1/187)+(1765×1/145)+(1765×1/81)+(1765×1/135)+(1765×1/4)+(1765×1/5)+(1765×1/15)+(1765×1/140)+(1765×1/36)+1765×1/1)+(1765×1/48)+(1765×1/29)+(1765×1/1)+(1765×1/81)+(1765×1/127)

=7,733

The marketing appearance frequency measurement of the present invention may be calculated from the keyword open score for moneycentral.com using the exponential transform in equation (1.2).

$${V}_{U} = γ ( 1 - {10}^{- {S}_{U}^{′} / {OBS}_{keywords}} ) \qquad ( 1.2 )$$

where:

OBS_{keywords} represents the total observations collected during the keyword searches; and

γ represents the convenience scaling factor.

Applying equation (1.2) to the calculated keyword open score yields the following results:

Vu=999×(1−10^{-(7733/764454)})

999×(1−0.9770)

=23

It will be noticed from the above calculation that the calculated marketing appearance frequency measurement is rounded up to the next higher integer. This is done strictly for a matter of convenience and is useful for purposes of avoiding having to deal with decimals in data tables maintained on computer 202 or database 203.

Traffic due to the relative visibility of the moneycentral.com points of presence in the keyword search engine media space may be predicted using equation (1.3) as follows.

T_{U}=β_{industry}V_{U} (1.3)

Tu=3055×23

=70,266

Thus, based on the calculated keyword visibility of 23, the predicted traffic for the moneycentral.com points of presence based solely on the visibility of the moneycentral.com points of presence in the keyword search engine media space is about 70,266 unique visitors per month.

### EXAMPLE 2

Example 2 illustrates how a category marketing appearance frequency measurement may be calculated in accordance with the present invention for a web site's points of presence. As with the first example, moneycentral.com and its related URLs are used as the target points of presence.

Initially, a plurality of category searches was performed on six different category search engines. The URLs returned for each category searched on each category search engine were observed. Table 4 lists the first appearance of the target points of presence for each category search that resulted in an appearance, the corresponding category search engine on which the appearance occurred, and the rank of the appearance in the search results.

TABLE 4

| Directory | Category | Listed | Target URL |
|---|---|---|---|
| Yahoo! | /Business_and_Economy/Finance_and_Investment/ | 2 | www.moneycentral.com/ |
| Categories | MSN_MoneyCentral/ | | |

The parameters needed to calculate the category marketing appearance frequency measurement for the moneycentral.com points of presence are discussed below.

First, a total of 1,073,776 points of presence, or URLs, were observed during the category searches performed in the initial step above. Thus, OBS_{categories}=1,073,776. Second, the scaling factor of convenience, γ, was set at 999 (γ=999) so that the maximum marketing appearance frequency measurement will be 999. Third, the λ_{engine}, λ_{category}, and α values were determined through prior linear regression of the category marketing appearance frequency measurement to traffic for sites having known traffic within the same industry as moneycentral.com. Tables 5 and 6 below provide the λ_{engine}, λ_{keyword}, and α values that were determined in the validation and calibration process.

TABLE 5
Engine Weightings:

| | Weighting Factor | Decay Factor |
|---|---|---|
| Engine | λ_{engine} | α_{category} |
| Yahoo! Categories | 1870 | 0 |
| Google | 1870 | 0 |
| AltaVista | 1870 | 0 |
| Yahoo! Web Pages | 1870 | 0 |
| AOL | 1870 | 0 |
| DMOZ | 1870 | 0 |

TABLE 6
Category Weightings:

| | Weighting Factor |
|---|---|
| Category | λ_{category} |
| /Business_and_Economy/Finance_and_Investment/MSN_MoneyCentral/ | 1 |

As seen from Table 5, λ_{engine} is the same for each of the category search engines. Similarly, it was determined that λ_{category} was the same for each of the searched categories. Thus, each category search engine and category are weighted the same. Furthermore, because α was determined to equal 0 for all category contexts, the value of each appearance in the category contexts is independent of the URL's placement on the category search results page. Hence, as seen from equation (2.1) below, the weighted value of each appearance in the category search context will be the same in the present example.

$${S}_{U}^{′} = {\sum }_{sightings} {λ}_{engine}^{′} {λ}_{keyword}^{′} {p}^{{α}_{category}} \qquad ( 2.1 )$$

where:

p represents the rank of the URL position on the page;

λ_{engine}, λ_{category} are weighting factors that were initially estimated empirically based on popularity and validated through linear regression; and

α_{category} is the decay factor that was modeled on consumer behavior in the category search results context and validated through linear regression.

Applying equation (2.1) to the data in Tables 4 through 6 above yields the following category open score calculation:

S′_{U}=1870×1×1

=1870

The marketing appearance frequency measurement of the present invention may be calculated from the category open score for moneycentral.com using the exponential transform in equation (2.2).

$${V}_{U} = γ ( 1 - {10}^{- {S}_{U}^{′} / {OBS}_{categories}} ) \qquad ( 2.2 )$$

where:

OBS_{categories} represents the total observations collected during the category searches; and

γ represents the convenience scaling factor.

Applying equation (2.2) to the calculated category open score yields the following results:

VU=999×(1−10^{-1870/1073776})

=999×(1−0.9960)

=4

Again, for convenience, the visibility was rounded up to the next higher integer. Thus, the relative category visibility is 4.

Traffic due to the relative visibility of the moneycentral.com points of presence in the category search engine media space could be estimated using equation (2.3) below.

T_{U}=β_{indusbty}V_{U} (2.3)

Any traffic predicted from equation (2.3) for the moneycentral.com points of presence would be based solely on the visibility of the moneycentral.com points of presence in the category search engine media space. It should be noted, however, that β_{industry} in equation (2.3) will typically be different than β_{industry} in equation (1.3). This is because β_{industry} will typically change with different media spaces, e.g., keyword, category, and third party pages, where the λ and α values used to calculate the frequency measurements corresponding to these media spaces have been determined for each individual media space rather than all of the media spaces combined.

### EXAMPLE 3

Example 3 illustrates how an inbound link marketing appearance frequency measurement may be calculated in accordance with the present invention for a web site's points of presence. As with the first two examples, moneycentral.com and its related URLs are used as the target points of presence.

Initially, a plurality of inbound link searches was performed on a large number of third party sites. The URLs that were returned for each inbound link search conducted on a third party page were observed. Table 7 identifies each appearance of the target points of presence and the corresponding third party page on which the appearance occurred. Because cc was determined to be equal to 0 for the inbound link context, the contribution of each target inbound link to traffic is independent of its placement on a particular page. As a result, the total number of inbound links per page is not reflected in Table 7.

TABLE 7
Inbound Link Sightings

| Target URL | Source Page |
|---|---|
| moneycentral.com | www.myfirstbillion.com |
| moneycentral.com | www.myfirstbillion.com/ |
| moneycentral.com | www.harcourtcollege.com/finance/mayo/websites.html |
| moneycentral.com | www.damont.com/SHOWROOM/pro/bank- |
| | financelink1.htm |
| moneycentral.com | www.damont.com/SHOWROOM/pro/bank- |
| | financelink1.htm |
| moneycentral.com | www.stockstartpage.com/ |
| moneycentral.com | www.stockstartpage.com |
| moneycentral.com | fog.ccsf.cc.ca.us/˜nmaffei/investments.htm |
| moneycentral.com | www.nulink.com/portal/business.html |
| moneycentral.com | bms.usouthal.edu/students/index.html |
| moneycentral.com | fog.ccsf.cc.ca.us/˜nmaffei/resources.htm |
| moneycentral.com | www.onlinemetro.com/businesscenter/articles/linx.html |
| moneycentral.com | www.tokyopc.org/meetings/1999/06/TPCUGInvest.htm |
| moneycentral.com | www.brillscontent.com/next/bestweb_links_0499.html |
| moneycentral.com | www.investingsites.com/ |
| moneycentral.com | www.investingsites.com |
| moneycentral.com | www.scsn.net/stock.html |
| moneycentral.com | www.odonnellweb.com/links.html |
| moneycentral.com | www.odonnellweb.com/links.html |
| moneycentral.com | www.odonnellweb.com/links.html |
| moneycentral.com | www.intac.com/˜sheldonk/invsig/pages/barrons.html |

The parameters needed to calculate the inbound link marketing appearance frequency measurement for the moneycentral.com points of presence are discussed below.

First, a total of 684,495 points of presence, or URLs, were observed during the inbound link searches performed in the initial step above. Thus, OBS_{inbounds}=684,495.

Second, the scaling factor of convenience, γ, was set at 999 (γ=999) so that the maximum marketing appearance frequency measurement will be 999. Third, λ_{inbound} and α values were determined through prior linear regression of the inbound link marketing appearance frequency measurement to traffic for sites having known traffic within the same industry as moneycentral.com. Table 8 below provides the λ_{inbound} and α values that were determined in the validation and calibration process.

TABLE 8
Source Page Weightings

| | Weighting Factor | Decay Factor |
|---|---|---|
| Source Pages | λ_{inbound} | α_{inbound} |
| www.myfirstbillion.com | 142 | 0 |
| www.myfirstbillion.com/ | 142 | 0 |
| www.harcourtcollege.com/finance/mayo/websites.html | 142 | 0 |
| www.damont.com/SHOWROOM/pro/bank- | 142 | 0 |
| financelink1.htm | | |
| www.damont.com/SHOWROOM/pro/bank- | 142 | 0 |
| financelink1.htm | | |
| www.stockstartpage.com/ | 142 | 0 |
| www.stockstartpage.com | 142 | 0 |
| fog.ccsf.cc.ca.us/˜nmaffei/investments.htm | 142 | 0 |
| www.nulink.com/portal/business.html | 142 | 0 |
| bms.usouthal.edu/students/index.html | 142 | 0 |
| fog.ccsf.cc.ca.us/˜nmaffei/resources.htm | 142 | 0 |
| www.onlinemetro.com/businesscenter/articles/linx.html | 142 | 0 |
| www.tokyopc.org/meetings/1999/06/TPCUGInvest.htm | 142 | 0 |
| www.brillscontent.com/next/bestweb_links_0499.html | 142 | 0 |
| www.investingsites.com/ | 142 | 0 |
| www.investingsites.com | 142 | 0 |
| www.scsn.net/stock.html | 142 | 0 |
| www.odonnellweb.com/links.html | 142 | 0 |
| www.odonnellweb.com/links.html | 142 | 0 |
| www.odonnellweb.com/links.html | 142 | 0 |
| www.intac.com/˜sheldonk/invsig/pages/barrons.html | 142 | 0 |

As seen from Table 8, λ_{inbound} is the same for each of the third party pages that were searched. Thus, each third party page is weighted the same. Furthermore, because ax was determined to equal 0 for all inbound link contexts, the value of each appearance in the inbound link contexts is independent of the URL's placement on the third party page on which it appears. Hence, as seen from equation (3.1) below, the weighted value of each appearance in the inbound link context will be the same in the present example.

$${S}_{U}^{′} = {\sum }_{sightings} {λ}_{inbound}^{′} {p}^{{α}_{inbound}} \qquad \text{(3.1)}$$

where

p represents the rank of the URL position on the page

λ_{inbound} is a weighting factor that was initially estimated empirically based on popularity and validated through linear regression; and

α_{inbound} is the decay factor that was modeled on consumer behavior in the inbound link context and validated through linear regression.

Applying equation (3.1) to the data in Tables 7 and 8 above yields the following inbound link open score calculation:

S_{U}=21×(142×1)

=2,982

Because α equals 0 and all of the values for λ_{inbound} are the same in the present example, the open score becomes simply the number of appearances times the λ_{inbound} weighting factor.

The marketing appearance frequency measurement of the present invention may be calculated from the inbound link open score for moneycentral.com using the exponential transform in equation (3.2).

$${V}_{U} = γ ( 1 - {10}^{\frac{- {S}_{U}^{′}}{{OBS}_{inbounds}}} ) \qquad \text{(3.2)}$$

where:

OBS_{inbounds} represents the total observations collected during the inbound link searches; and

γ represents the convenience scaling factor.

Applying equation (3.2) to the calculated inbound link open score yields the following results:

V_{U}=999×(1−10⁻²⁹⁸²¹⁶⁸⁴⁴⁹⁵)

=999×(1−0.9900)

=10

Again, for convenience, the visibility was rounded up to the next higher integer. Thus, the relative inbound link visibility is 10 for the online moneycentral.com points of presence.

Traffic due to the relative visibility of the moneycentral.com points of presence in the third party inbound link media space could be estimated using equation (3.3) below.

T_{U}=β_{industry}V_{U} (3.3)

Any traffic predicted from equation (3.3) for the moneycentral.com points of presence would be based solely on the visibility of the moneycentral.com points of presence in the third party page media space. It should be noted, however, that β_{inddusty} in equation (3.3) will be different than β_{industry} in equations (1.3) and (2.3).

### EXAMPLE 4

Example 4 illustrates how a multi-component marketing appearance frequency measurement may be calculated in accordance with the present invention for a web site's online points of presence. As with the first three examples, moneycentral.com and its related URLs are used as the target points of presence in this example.

The multi-component marketing appearance frequency measurement calculated in the present example is based on the relative visibility of the money central.com points of presence in the keyword search engine, category search engine, and third party media spaces. The frequency measurement of the present example is thus simply the sum of the component open scores followed by an exponential transformation of the combined open scores adjusted for the scope of the search. In performing this calculation, however, different λ values are used than were used in the prior examples. Different λ values are required to calculate the component open scores in the present example because the X values used in the first three examples were determined by mapping the individual component open scores directly to traffic through linear regression. In the overall model, however, the searched media spaces will not contribute equally to traffic.

The appropriate )values for calculating the multi-component frequency measurement may be determined by mapping the multi-component frequency measurement to traffic as described above and then validating and calibrating the λ values through linear regression. However, rather than starting with new λ values for the overall model it is useful to start with the λ values determined from mapping the component frequency measurements to traffic and then tuning the values from there. The tuned X values may then be used to calculate the multi-component open score using equation (1) above. The open score may then be adjusted for the scope of the search and exponentially transformed into the frequency measurement using equation (4) above.

As those skilled in the art will appreciate, the multi-component frequency measurement may also be calculated by appropriately weighting the component open scores calculated in the above examples to take into account their contribution to the overall model and then exponentially transforming the result to arrive at the frequency measurement. This may be done practically by performing a reverse-exponential transformation on the individual component marketing appearance frequency measurements followed by calculating a simple weighted average of the component open scores to arrive at a combined open score that is already adjusted for the scope of the search. The resulting open score may then be exponentially transformed to arrive at the multi-component frequency measurement and the overall visibility for the target points of presence. Table 9 below summarizes the data that would be used in calculating a multi-component marketing appearance frequency measurement in this manner.

TABLE 9

| Symbol | Name | Value |
|---|---|---|
| V_{keyword} | Keyword Visibility | 23 |
| V_{category} | Category Visibility | 4 |
| V_{inbound} | Inbound Link Visibility | 10 |
| λ_{keywords} | Keyword Open Score Adjustment | 2.1 |
| | Factor | |
| λ_{categories} | Category Open Score Adjustment | 1.1 |
| | Factor | |
| λ_{inbounds} | Inbound Link Open Score Adjustment | 0.6 |
| | Factor | |
| γ | Convenience Factor | 999 |
| β_{industry} | Adjustment for Predicting Traffic in | 4600 unique |
| | this industry | visitors/month |

Equation (4.1) illustrates the general equation for performing the reverse exponential transformation on the component frequency measurements calculated in Examples 1 through 3 above.

$${S}^{′} = - {log}_{10} ( 1 - \frac{V}{γ} ) \qquad \text{(4.1)}$$

In equation (4.1) V and γ are as calculated before. On the other hand, S′ essentially equals the component open score divided by Sₘₐₓ for the appropriate context. Using equation (4.2) below, a simple weighted average may be calculated that yields a combined open score that is already adjusted for the scope of the search.

$${S}_{UTotal}^{′} = \frac{{λ}_{keywords} {S}_{keywords} + {λ}_{categories} {S}_{categories} + {λ}_{inbounds} {S}_{inbounds}}{{λ}_{keywords} + {λ}_{categories} + {λ}_{inbounds}} \qquad \text{(4.2)}$$

Thus, in equation (4.2), S′_{Utotal} is a modified combined open score that approximates S_{Utotal} divided by Sₘₐₓ, where Sₘₐₓ is the maximum combined open score for the keyword, category and inbound link media spaces. The λ values in equation (4.2) are calculated for the entire model using linear regression on each industry.

The exponential transformation for transforming the modified open score resulting from equation (4.2) to the marketing appearance frequency measurement is given by equation (4.3).

V_{U}=γ(1−10^{-S′}^{_{U}}) (4.3)

Applying equations (4.1) through (4.3) to the data in Table 9 yields the following marketing appearance frequency measurement:

V_{U}=999×(1−10^{-((2.1)log(1-23/999)+(1.1)log(1-4 999)+(0.6) log(1-10/999))/(2.1+1.1+0.6)})

=999×(1−10^{-((2.1)(-0.010115671)+(1.1)(-0.001742407)+(0.6)(-0.004369197))(3.8)})

999×(1−10^{-(112178/3.8)})

999×(1−0.9845)

=16

As with the prior examples, the resulting visibility is rounded up to the next higher integer. As a result, the relative combined keyword, category, and inbound link visibility for the online moneycentral.com points of presence is 16.

Traffic due to the relative visibility of the moneycentral.com points of presence in the combined media spaces may be estimated using equation (4.4) as follows.

T_{U}=β_{industry}V_{U} (4.4)

T_{U}=4600×16

=73,600

Based on the calculated multi-component visibility of 16, the predicted traffic due to the moneycentral.com points of presence in the searched media spaces is about 73,600 unique visitors per month.

### EXAMPLE 5

The present example illustrates how a marketing appearance frequency measurement may be calculated for an offline media space. The offline point of presence used for purposes of illustration in the present example is billboards, with the target points of presence being billboards of the XYZ company.

Initially a search would be conducted in the geographical area(s) of interest in order to observe all billboards present within the searched area. Each of the observed billboards would count as an observation. Further, for any appearance of the target point of presence, relevant data would be collected for purposes of weighting the appearance. For example, in the context of billboards, the intersection or other location at which the billboard appears would be relevant to the amount of consumer traffic that passes the billboard by each day. Further, the size of the billboard will likely impact on whether consumers that actually pass the billboard will see the billboard and act on it in terms of the business attribute being tracked. Thus, an open score for the target billboard sightings may be calculated using equation (5.1) below.

$${S}_{billboard}^{′} = {\sum }_{sightings} {λ}_{intersection}^{′} {p}^{{α}_{intersection}} \qquad \text{(5.1)}$$

where:

p represents the rank of the size of the billboard;

λ_{intersection} is estimated based on popularity and validated through linear regression; and

α_{intersection} is modeled on consumer behavior and validated through linear regression.

Further, the relative visibility of the company's billboard points of presence may be calculated using equation (5.2).

$${V}_{billboard} = γ ( 1 - {10}^{\frac{- {S}_{billboard}^{′}}{{OBS}_{billboards}}} ) \qquad \text{(5.2)}$$

where:

OBS_{billboards} represents the total observations collected; and

γ represents the convenience scaling factor.

Finally, the visibility of the company's billboards could be mapped to consumer awareness using equation (5.3) to determine how many consumers are aware of the company based on the company's billboards.

A_{billboards}=β_{industry}V_{billboards} (5.3)

For purposes of the present example, it is assumed that an area of Los Angeles was searched that contained 4,495 billboards and that as a result of the search four appearances of the target XYZ billboards were identified, which are identified in Table 10. Based on the number of observed billboards, OBSbillboards would equal 4,495 in this example.

TABLE 10

| Company | Intersection | Size |
|---|---|---|
| XYZ | Wilshire & Sunset | 2 |
| XYZ | Wilshire & Sunset | 3 |
| XYZ | Detroit & Beverly | 2 |
| XYZ | Detroit & Sunset | 1 |

If the traffic at the intersections where sightings occurred was as given in Table 11, then λ_{intersection} values as given in Table 11 could be initially assigned. Furthermore, based on consumer behavior it may be initially assumed that the likelihood that any consumer passing by a particular billboard will see it and then become aware of the referenced company will vary by the square root of the size of the billboard. As a result, an α_{intersection} value of ½ may be assigned initially to all billboard contexts.

TABLE 11

| Intersection | Automobile | Weighting Factor | Decay Factor |
|---|---|---|---|
| Weightings: | Traffic | λ_{intersection} | α_{instersection} |
| Wilshire & | 50,000 cars/day | 50 | ½ |
| Sunset | | | |
| Detroit & | 60,000 cars/day | 60 | ½ |
| Beverly | | | |
| Detroit & | 20,000 cars/day | 20 | ½ |
| Sunset | | | |

Using equation (5.1) and the foregoing data, a billboard open score may be calculated for the XYZ billboards as follows:

S′_{company}=50×2^{½}+50×3^{½}+60×2^{½}+20×1^{½}

=70.71+86.60+84.85+20.00

=262

If a scaling factor of convenience of 999 (γ=999) is used then the visibility of the XYZ company's billboard points of presence may be calculated as follows.

V_{billboards}=999×(1−10^{-262/4495)}

=999×(1−0.8743)

=126

As before, the calculated visibility is rounded up. As a result, the calculated visibility of the XYZ company's billboard points of presence is 126. However, to ensure that the resulting visibility measurement is an accurate predictor of consumer awareness, the initial λ and α values should be validated and calibrated through linear regression. This may be done by calculating the frequency measurement for a number of companies having a known level of consumer awareness and then mapping the frequency measurement to consumer awareness for the known sites. The values of λ and α would then be tuned to reduce the sum of the errors to an acceptable level.

Although the invention has been described with reference to preferred embodiments and specific examples, it will readily be appreciated by those skilled in the art that many modifications and adaptations of the invention are possible without deviating from the spirit and scope of the invention. Thus, it is to be clearly understood that this description is made only by way of example and not as a limitation on the scope of the invention as claimed below.

What is claimed is:

1. A method of determining a marketing appearance frequency measurement for at least one target point of presence for a company, the method comprising:
searching at least one media space to determine the number of times the at least one target point of presence appears within the at least one media space;
calculating weighted values for each appearance;
calculating an open score by summing the weighted values;
calculating a marketing appearance frequency measurement for the at least one target point of presence, wherein the marketing frequency measurement is equal to an exponential function of the open score adjusted for the scope of the search, and the weighted values are weighted so that the marketing appearance frequency measurement is proportional to a business attribute to be tracked.

2. The method of claim 1, further comprising calculating an open score for each media space, wherein each open score is additive so that the open scores can be added to derive a combined open score, which is used to calculate the marketing appearance frequency measurement.

3. The method of claim 1, wherein adjusting the open score for the scope of the search comprises dividing the open score by an estimation of the maximum open score for the at least one media space searched.

4. The method of claim 1, wherein adjusting the open score for the scope of the search comprises dividing the open score by the total number of points of presence of the same type as the at least one target point of presence that were observed during the search.

5. The method of claim 1, wherein the exponential function comprises a term equal to 1 minus the exponential of the open score adjusted for the scope of the search.

6. The method of claim 5, wherein the exponential function further includes a scaling factor designed to place the resulting marketing appearance frequency measurement within a predetermined range.

7. The method of claim 1, wherein the media spaces comprise offline sources, online sources, or both.

8. The method of claim 1, wherein the weighted values are calculated to represent the likelihood each appearance will be seen and effect the business attribute being tracked.

9. The method of claim 1, further comprising the step of validating the marketing appearance frequency measurement to known customer traffic, sales, or both.

10. The method of claim 9, further comprising the step of calibrating the marketing appearance frequency measurement using known traffic, sales, or both.

11. The method of claim 1, further comprising the step of using the marketing appearance frequency measurement to predict at least one of the following:
customer traffic;
sales;
stock price;
advertising expenditures; and
awareness.

12. The method of claim 11, further comprising the step of using the marketing appearance frequency measurement to identify the sources of customer traffic resulting from the at least one target point of presence.

13. The method of claim 1, further comprising the steps of calculating a marketing appearance frequency measurement for at least one target point of presence for a plurality of companies and generating a marketing appearance frequency index from the calculated marketing appearance frequency measurements.

14. The method of claim 1, wherein the at least one media space searched includes at least one of the following media spaces: telephone books, press releases, news articles, billboards, keyword-driven Internet search engines, categorical directories on Internet search engines, World-Wide Web banner ads, and other World-Wide Web pages.

15. A method of determining a marketing appearance frequency measurement for at least one target URL of a company, the method comprising:
searching at least one media space on World-Wide Web sites to determine the number of times the at least one target URL appears within the at least one media space;
calculating weighted values for each appearance;
calculating an open score by summing the weighted values;
calculating a marketing appearance frequency measurement for the at least one target URL, wherein the marketing frequency measurement is equal to an exponential function of the open score adjusted for the scope of the search, and the weighted values are weighted so that the marketing appearance frequency measurement is proportional to a business attribute to be tracked.

16. The method of claim 15, further comprising calculating an open score for each media space, wherein each open score is additive so that the open scores can be added to derive a combined open score, which is used to calculate the marketing appearance frequency measurement.

17. The method of claim 15, wherein the searched media spaces include at least one of the following:
keyword driven search result pages;
search engine category pages;
incoming links on third party pages;
internet chat rooms;
internet news groups;
company press releases; and
banner ads on any page.

18. The method of claim 16, wherein the searched media spaces include at least one of the following:
keyword driven search result pages;
search engine category pages;
incoming links on third party pages;
internet chat rooms;
internet news groups;
company press releases; and
banner ads on any page.

19. The method of claim 15, wherein each appearance is weighted based on the likelihood that the appearance will be seen by a potential customer and effect the business attribute being tracked.

20. The method of claim 19, wherein the business attribute being tracked is customer traffic.

21. The method of claim 20, further comprising the step of using the marketing appearance frequency measurement to predict customer traffic to the at least one target URL.

22. The method of claim 15, wherein the weighted values are calculated to represent the likelihood each appearance will be seen and effect the business attribute being tracked.

23. A computer, comprising:
a memory configured to store a computer program and data; and
a processor configured to run the computer program, the computer program configured to perform the following functions:
search certain pages on certain World-Wide Web sites to collect a set of observations relating to at least one target point of presence for a company;
compute weighted values for each appearance of the target point or points of presence;
compute an open score by summing the weighted values; and
compute a marketing appearance frequency measurement from the open score for the target point or points of presence, wherein the marketing frequency measurement is equal to an exponential function of the open score adjusted for the scope of the search, and the weighted values are weighted so that the marketing appearance frequency measurement is proportional to a business attribute to be tracked.

24. The computer of claim 23, wherein the computer program further calculates a marketing appearance frequency measurement for at least one target point of presence for a plurality of companies and generates a marketing appearance frequency index from the calculated marketing appearance frequency measurements.

25. The computer of claim 23, wherein the computer program further estimates traffic for the at least one target point of presence based on the marketing appearance frequency measurement.

26. The computer of claim 23, wherein the computer program further calculates a marketing frequency index for any number of companies having one or more points of presence in the same media space as the at least one target point of presence.

27. The computer of claim 23, wherein the computer program adjusts the open score for the scope of the search by dividing the open score by an estimation of the maximum open score for the at least one media space searched.

28. The computer of claim 23, wherein the computer program adjusts the open score by dividing the open score by the total number of points of presence of the same type as the at least one target point of presence that were observed during the search.

29. The computer of claim 23, wherein the exponential function used by the computer program comprises a term equal to 1 minus the exponential of the open score adjusted for the scope of the search.

30. The computer of claim 29, wherein the exponential function used by the computer program further includes a scaling factor designed to place the resulting marketing appearance frequency measurement within a predetermined range.

31. The computer of claim 23, wherein the calculated weighted values represent the likelihood each appearance will be seen and effect the business attribute being tracked.
